(19) United States
(12) Patent Application Publication
(10) Pub. No.: US 2008/0053502 A1
(43) Pub. Date: Mar. 6, 2008

(54) LABOR-SAVING PNEUMATIC CRUTCH

(76) Inventor: Mei-Chuan Tseng, Beidou Township (TW)

Correspondence Address: RABIN & Berdo, PC, 1101 14TH STREET, NW, SUITE 500, WASHINGTON, DC, 20005, US

(21) Appl. No.: 11/934,323

(22) Filed: Nov. 2, 2007

Related U.S. Application Data
(63) Continuation-in-part of application No. 10/888,994, filed on Jul. 13, 2004.

(51) Int. Cl. A61H 3/02

(52) U.S. Cl. 135/69

(57) ABSTRACT

A labor-saving pneumatic crutch includes a crutch body, an air pressure modulator and a support crutch body. The air pressure modulator of the pneumatic crutch is installed in the crutch body and fixed to the support crutch body, such that when a user sits or stands up, the weight of the user's body is pressed onto the pneumatic crutch, and the user can turn a switch brake plate of the air pressure modulator to drive the air pressure rod spindle to extend or shorten the length of the support crutch body in the crutch body.

### CROSS-REFERENCE TO RELATED APPLICATION

This application is a Continuation-In-Part patent application of U.S. application Ser. No. 10/888,994, filed Jul. 13, 2004.

### BACKGROUND OF THE INVENTION

1. Field of the Invention

The present invention relates to a labor-saving pneumatic crutch, and more particularly to a crutch for supporting handicaps and people who are injured or inconvenient to walk, stand or sit, and achieves the effects of providing a safe and secured support to users and a labor-saving adjustment of the crutch.

2. Description of the Related Art

Referring to FIGS. 1 and 2 for a general prior art crutch 10, the crutch 10 includes a crutch body 11 and a contractible crutch body 15, and the top of the crutch body 11 has a soft cushion 12, and the bottom of the crutch body 11 has a plurality of through holes 14 disposed at a hollow crutch body 13 for adjusting the position of the crutch 10, and the contractible crutch body 15 is sheathed into the crutch body 13 of the crutch 10, and the top of the interior of the contractible crutch body 15 has a resilient latch 16 for latching into the through hole 14 of the crutch body 13 for positioning, and the bottom of the contractible crutch body 15 has a slippery-resisting pad 17. When a user wants to adjust the length of the crutch, the user presses the resilient latch 16 directly to separate the through hole 14 of the crutch body 13, and then pulls out the contractible crutch body 15 or draws the contractible crutch body 15 back into the crutch body 11, and then latches the resilient latch 16 into the corresponding through hole 14 for positioning, so as to complete adjusting the length of the crutch.

However, the foregoing prior art structure still has the following drawbacks:

1. The crutch 10 is latched into the through hole 14 of the crutch body 11 by the resilient latch 16 of the contractible crutch body 15 to set a fixed length. If the user wants to sit down, the user needs to set the crutch 10 to a slanting position before the user can sit down slowly. By then, the crutch 10 has lost its support function, and the user may lose balance and fall easily.

2. If the user wants to stand up with the assistance of the crutch 10, the user needs to apply a force to the slanting crutch 10 before standing up, and thus requiring much effort. Furthermore, there is a risk of losing balance and falling easily.

Based on the aforementioned drawbacks, a pneumatic crutch as disclosed in U.S. Pat. No. 4,252,137 was introduced, and the pneumatic crutch uses a control rod disposed at the lower edge of the handle for the control of the crutch, or a user presses a press button installed in a handle and an air pressure rod corresponding to a ball inside a push rod for the control of extending or contracting the crutch by a change of air pressure. The assembly of the overall structure is complicated, and its control is incompliant with ergonomics, and thus is not good enough for practical applications.

In view of the foregoing shortcomings, the inventor of the present invention based on years of experience to conduct extensive experiments and modifications, and finally developed a labor-saving pneumatic crutch in accordance with the present invention.

### SUMMARY OF THE INVENTION

In view of the foregoing shortcomings of the prior art, the inventor of the present invention based on years of experience in the related industry to conduct extensive researches and experience, and finally developed a labor-saving pneumatic crutch in accordance with the present invention.

The primary objective of the present invention is to overcome the shortcomings of the prior art by providing a labor-saving pneumatic crutch, wherein an air pressure modulator of the pneumatic crutch is installed in the crutch body and fixed to a support crutch body, such that when a user sits down or stands up, the user applies his/her body weight onto the pneumatic crutch, and turns the switch brake plate of the air pressure modulator, such that the air pressure rod spindle drives the support crutch body to extend or contract in the crutch body, and the user no longer needs much effort to obtain a stable and secured support.

### BRIEF DESCRIPTION OF THE DRAWINGS

FIG. 1 is a perspective view of a prior art crutch;

FIG. 2 is a section view of a portion of a prior art crutch;

FIG. 3 is a perspective view of the present invention;

FIG. 4 is a section view of a portion of the present invention;

FIG. 5 is a schematic view of operating movements of the present invention;

FIG. 6 is a schematic view of using the present invention;

FIG. 7 is a schematic view of using the present invention;

FIG. 8 is a section view of a structure of an air pressure modulator and a support crutch body at a state of being contracted;

FIG. 9 is a section view of a section of FIG. 8;

FIG. 10 is a section view of a structure of an air pressure modulator and a support crutch body at a state of being extended; and

FIG. 11 is a section view of a section of FIG. 10.

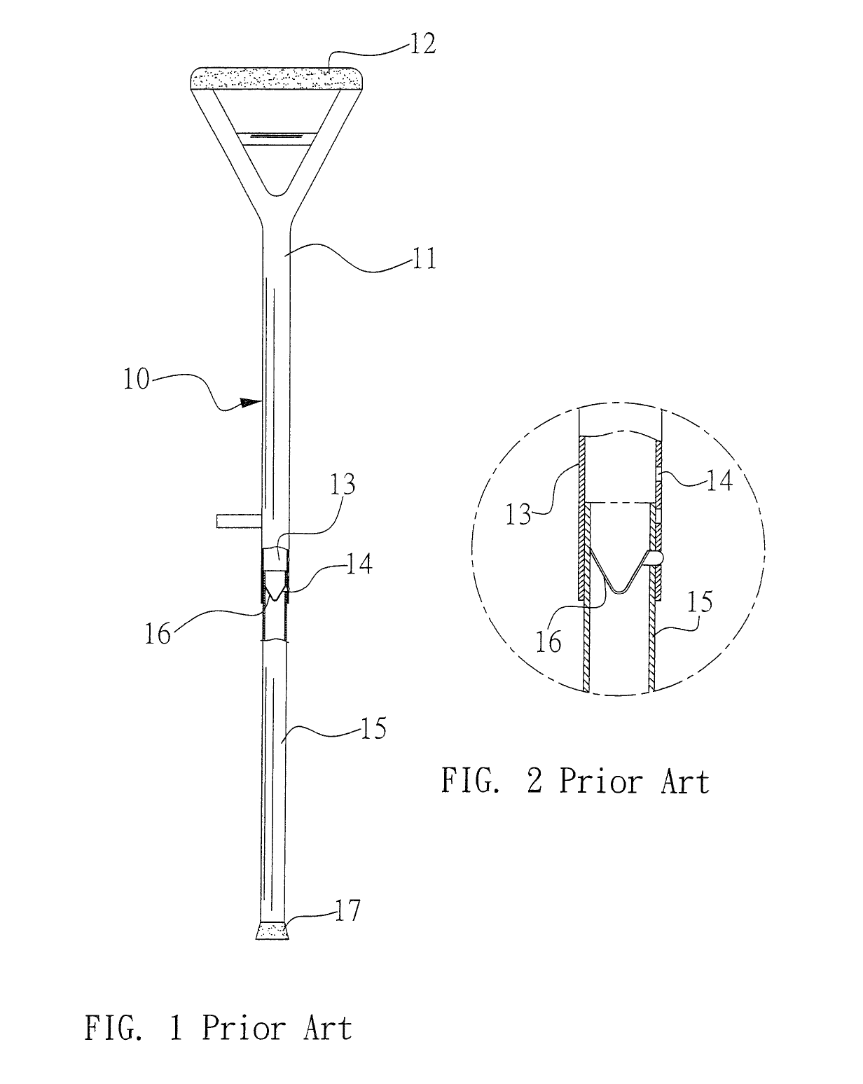

### DETAILED DESCRIPTION OF THE PREFERRED EMBODIMENTS

The present invention is described in detail by embodiments accompanied with the drawings as follows:

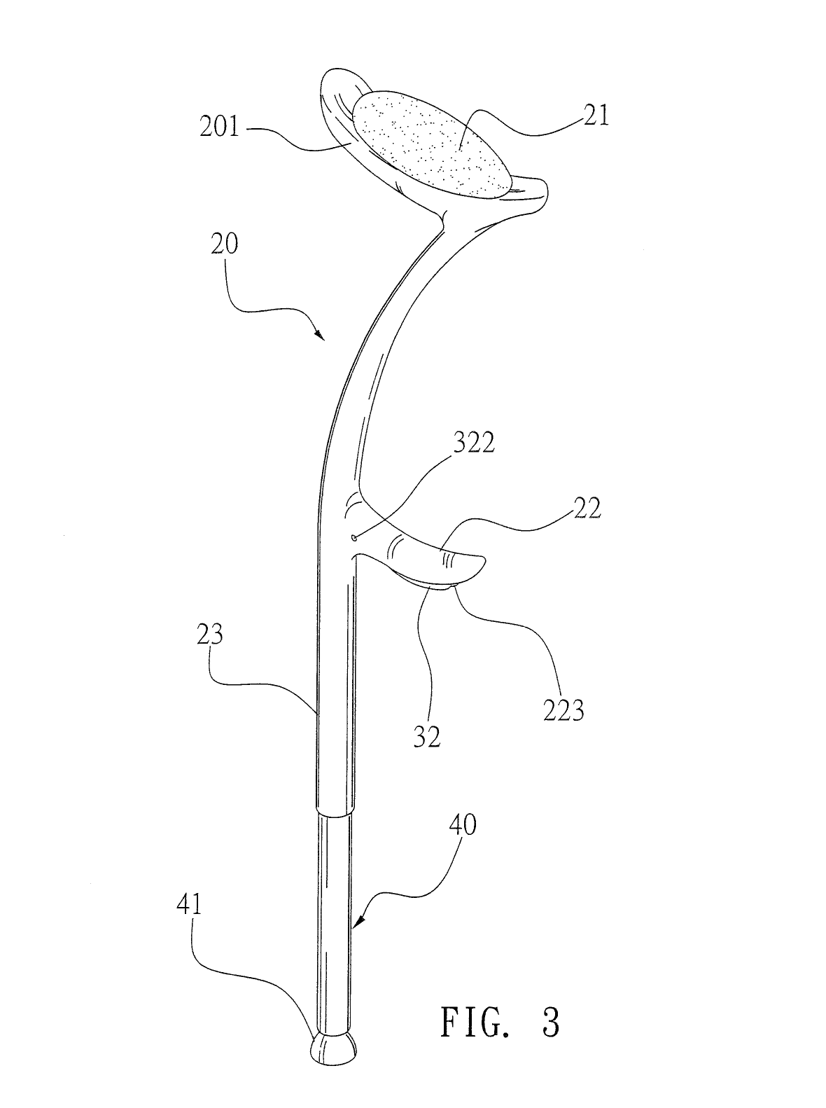

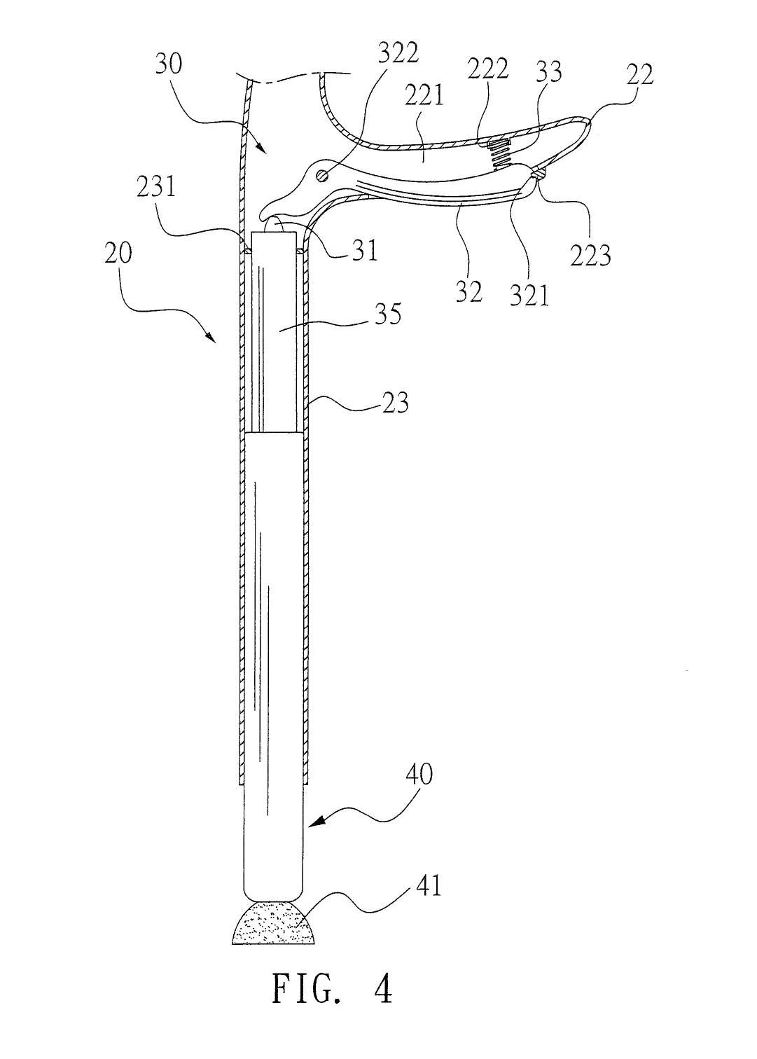

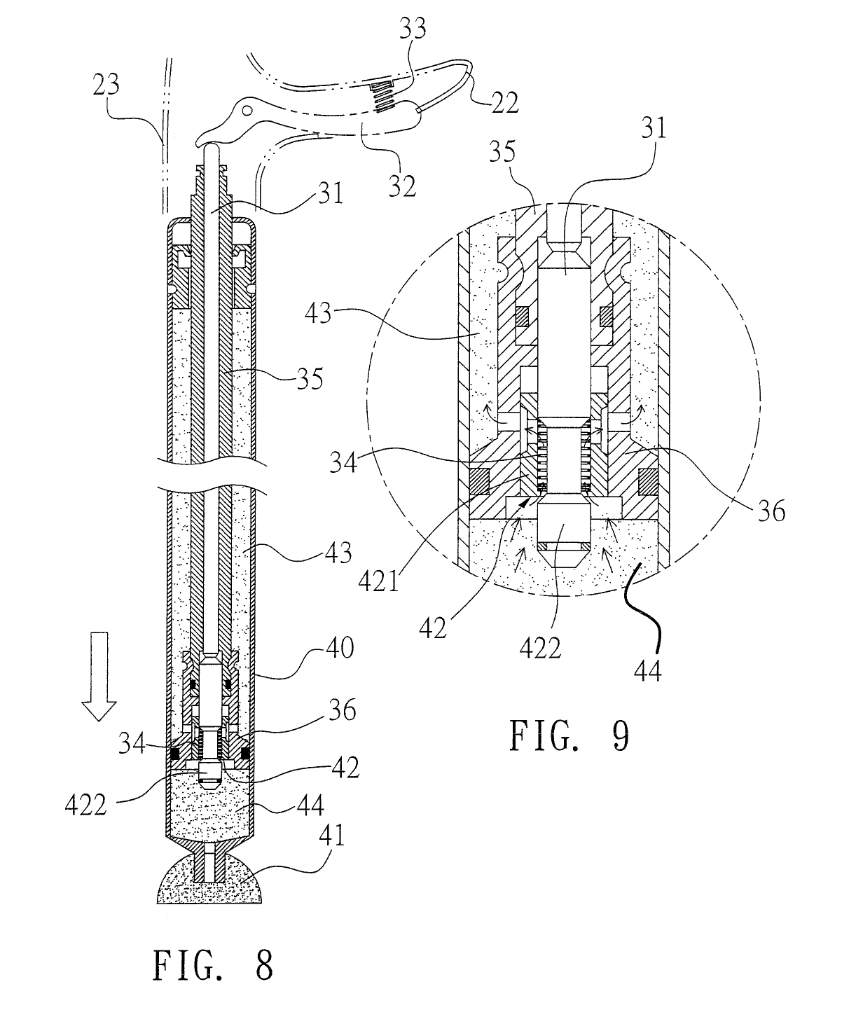

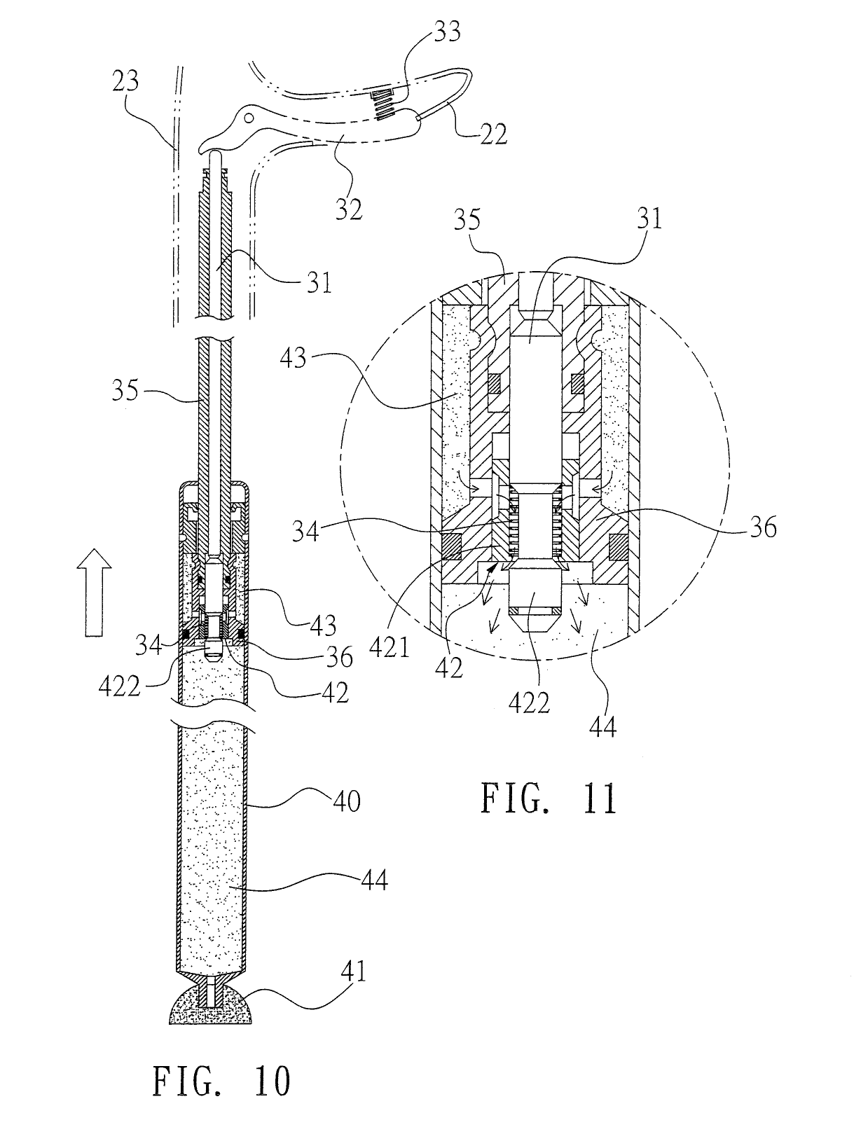

Referring to FIGS. 3, 4, 8 and 10 for a labor-saving pneumatic crutch of the invention, the labor-saving pneumatic crutch comprises a crutch body 20, a spring 33, an air pressure modulator 30 and a support crutch body 40. The top of the crutch body 20 has a soft cushion 21, and a handle 22 is protruded from the middle of the crutch 20 and provided for users to hold by hand, and a containing groove 221 is disposed at the bottom of the handle 22. The containing groove 221 has a position limit slot 222, and a lateral side of the containing groove 222 has a positioning switch 223. The handle 22 has a hollow tubular crutch body 23 below, and a loop of fixing edge 231 is disposed at an appropriate position of the top of the interior of the crutch body 23. The air pressure modulator 30 has an air pressure rod spindle 31 installed in the air pressure rod 35, and the bottom of the air pressure rod 35 is coupled with a plunger 36. The bottom of the plunger 36 has a valve module 42, and a spring 44 is connected between the internal hole of the valve module 42 and the axle portion 422 at the bottom of the air pressure rod spindle 31, and the top of the air pressure rod spindle 31 has a switch brake plate 32. The switch brake plate 32 has a positioning slot 321, and the air pressure rod spindle 31 of the air pressure modulator 30 is installed in the support crutch body 40. The support crutch body 40 is a hollow tubular body, and its bottom installs a slippery-resisting pad 41, such that both upper and lower ends of the support crutch body 40 are sealed, and the interior is divided into two compressed air chambers 43, 44. During installation, the top of the air pressure rod spindle 31 of the air pressure modulator 30 is fixed to the fixing edge 231 of the crutch body 23, and the switch brake plate 32 is accommodated in the containing groove 221 of the handle 22, and a position limit slot 222 is disposed at the middle position of the containing groove 221 for fixing an end of the spring 33, and another end of the spring 33 is pressed at the upper distal surface of the switch brake plate 32, and the support crutch body 40 is fixed to the bottom of the air pressure rod spindle 31 of the air pressure modulator 30 to complete the installation.

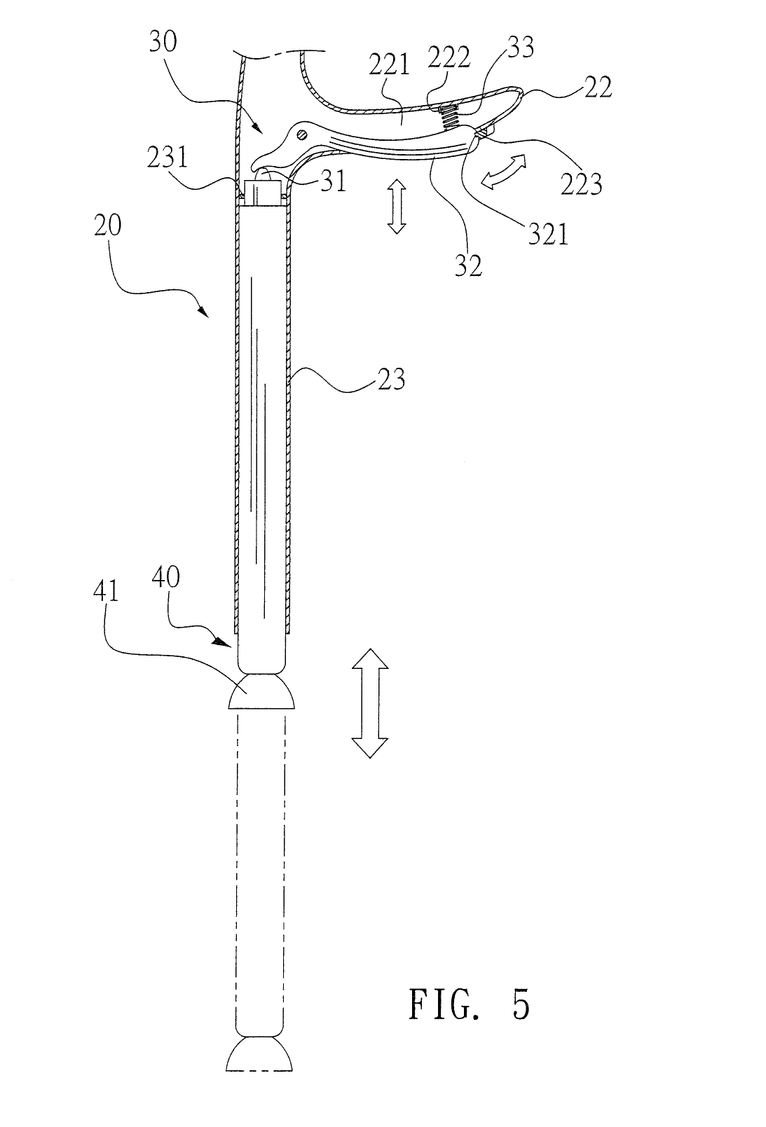

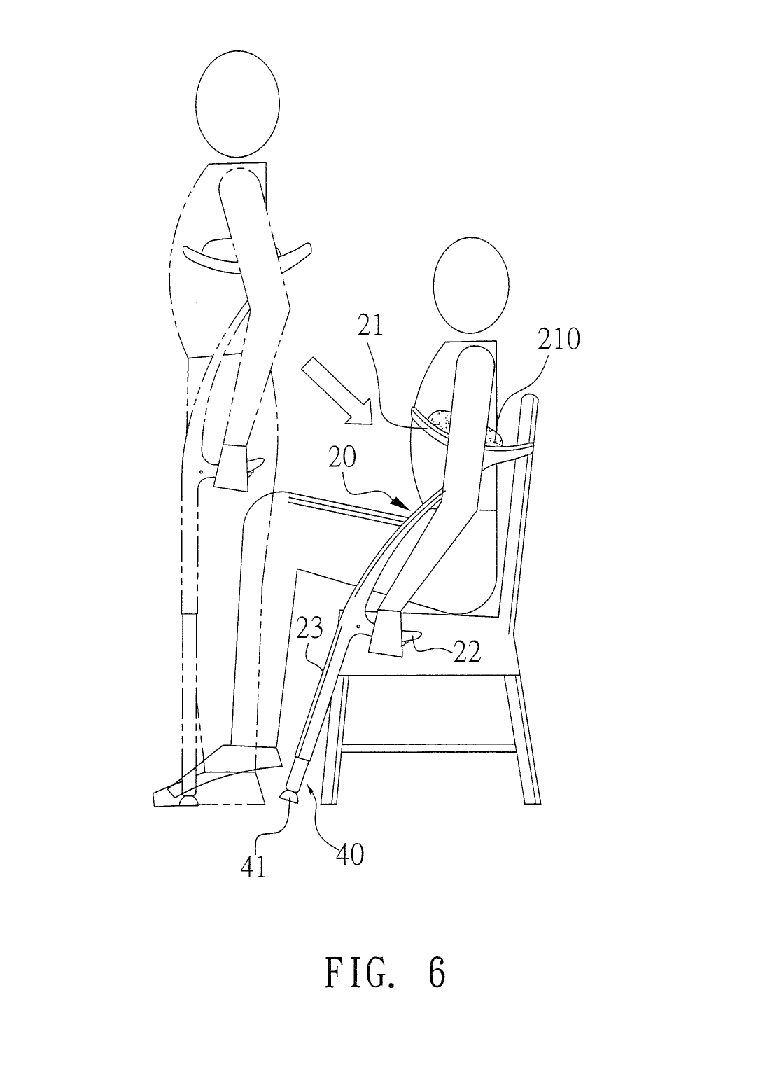

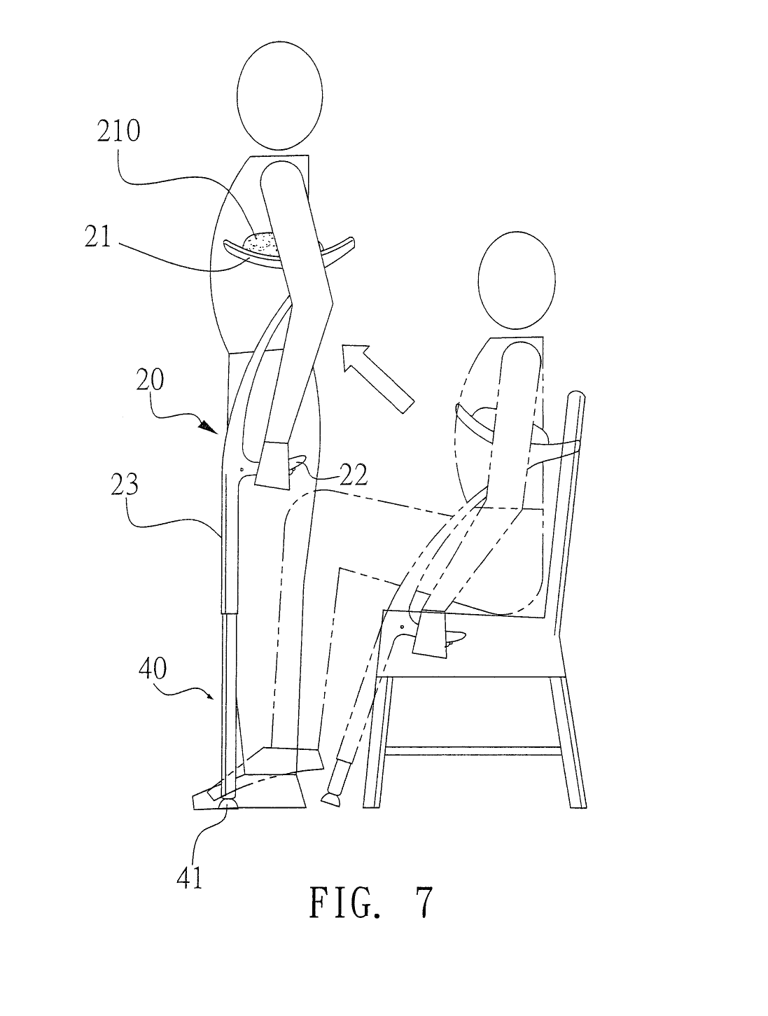

Refer to FIGS. 5 to 11 for the operating movements of the labor-saving pneumatic crutch in accordance with the present invention.

1. Under normal condition, if the switch brake plate 32 has not pressed on the air pressure rod spindle 31, the spring 34 will push the air pressure rod spindle 31 upward, and thus the valve module 42 will be sealed by the axle portion 422 of the air pressure rod spindle 31, and the compressed air chambers 43, 44 will not be interconnected with each other, and the air inside will not flow into the other compressed air chamber 43, 44. As a result, the relation between the air pressure rod spindle 31 and the support crutch body 40 can be maintained to achieve the effect of positioning the crutch body 20 and the support crutch body 40.

2. If a user wants to sit down, the user can press the switch brake plate 32 at the air pressure rod spindle 31 by hand, so that the air pressure rod spindle 31 moves downward to separate the axle portion 422 at the bottom form the valve module 42, and the valve module 42 is in an open state for interconnecting the compressed air chambers 43, 44. With the pressing force caused by the sitting of the user, the air in the compressed air chamber 44 flows towards the other compressed air chamber 43, so that the air pressure rod spindle 31 and the support crutch body 40 produce a mutual withdrawing effect, and the support crutch body 40 can be drawn back into the crutch body 20, so as to achieve the effect of reducing the length of the crutch and allowing the user to sit down smoothly.

3. If the user wants to stand up, the user can press the switch brake plate 32 to trigger the air pressure rod spindle 31, such that the air pressure spindle 31 moves down to separate the bottom of the axle portion 422 from the valve module 42, and the valve module 42 is in an open state, and the compressed air chambers 43, 44 are interconnected, and the air in the compressed air chamber 43 returns into the compressed air chamber 44. While the user is standing up, the air pressure rod spindle 31 will be pushed up and extended out from an external end of the crutch body 20 with respect to the support crutch body 40 to achieve the effect of increasing the length of the crutch and cope with the function of supporting the user to stand up.

4. If the user wants to sit down or stand up, the user must reduce and increase the length of the crutch respectively. In the whole process, the valve module 42 must be maintained at an open state, so that the air in one of the two compressed air chambers 43, 44 can flow to the other compressed air chamber 44, 43. To cope with the user's movements of standing up or sitting down, the length of the crutch can be adjusted. Since the user no longer needs to control the length of the crutch when the user stands up or sits down, therefore the valve module 42 must be shut to maintain the length of the crutch without the risk of changing the length unexpectedly.

The structure of the embodiment has the following advantages:

1. If a user wants to sit down, the user's body weight is exerted onto the crutch body 20 to adjust the air pressure rod spindle 31 to move downward while driving the support crutch body 40 to draw back into the crutch body 23. When the pneumatic crutch is adjusted to an appropriate length, and the positioning switch 223 is latched into the positioning slot 321 of the switch brake plate 32, so that when the user sits down with the assistance of the pneumatic crutch, the user can have a stable and secured support.

2. If the user wants to stand up, the user's body weight can be exerted onto the crutch body 20 to release the air pressure rod spindle 31 of the air pressure modulator 30 and drive the support crutch body 40 to extend the crutch body 23 in order to stand up slowly until the user has stood up completely. The positioning switch 223 is then latched into the positioning slot 321 of switch brake plate 32, so that the user does not need too much effort to stand up with a safe and secured support.

From the description above, the invention is definitely in compliance with the requirements of patent application, and is thus duly filed for patent application.

What is claimed is:

1. A labor-saving pneumatic crutch, comprising: a crutch body, an air pressure modulator and a support crutch body, and the top of the crutch body installing a soft cushion, and a handle is protruded from the middle of the crutch body and provided for a user's hand to hold, and a hollow tubular crutch body is disposed further down of the crutch body, and the support crutch body is a hollow tubular hollow body, and a slippery-resisting pad is sheathed to the bottom of the crutch body; characterized in that:
the air pressure modulator includes an air pressure rod spindle installed in the air pressure rod, and the bottom of the air pressure rod is coupled to a plunger, and the bottom of the plunger has a valve module, and a spring is installed between an internal hole of the valve module and an axle portion at the bottom of the air pressure rod spindle, and the top of the air pressure rod spindle has a switch brake plate, and the switch brake plate has a positioning slot, and the air pressure rod spindle of the air pressure modulator is installed in the support crutch body, and the support crutch body is a hollow tubular body, and a slippery-resisting pad is sheathed to the bottom of the crutch body, such that both upper and lower ends of the support crutch body are sealed, and the interior includes two compressed air chambers, so that whether or not the switch brake plate at the top of the air pressure rod spindle presses against the air pressure rod spindle determines whether or not to control valve module to open, and with the convection of air in the two compressed air chambers and the standing up or sitting down movement of the user drive the air pressure rod spindle to extend or reduce the support crutch body in the crutch body, so as to achieve the effect of adjusting the length of the crutch.

2. The labor-saving pneumatic crutch of claim 1, wherein the top of the air pressure rod spindle of the air pressure modulator is fixed to a fixing edge of the crutch body, and the switch brake plate is accommodated into the handle containing groove, and a position limit slot is disposed at the middle of the containing groove, and a spring is clamped between the position limit slot and the switch brake plate, such that the pushing effect of the spring can maintain the switch brake plate at a status of not pressing at the air pressure rod spindle.
